(19) United States
(12) Patent Application Publication
(10) Pub. No.: US 2012/0057361 A1
(43) Pub. Date: Mar. 8, 2012

(54) Novelty Trailer Hitch Lighted Figure

(76) Inventor: Jeffrey Corliss, Cape Coral, FL (US)

(21) Appl. No.: 13/118,652

(22) Filed: May 31, 2011

Related U.S. Application Data
(60) Provisional application No. 61/379,973, filed on Sep. 3, 2010.

(51) Int. Cl. B60Q 1/44

(52) U.S. Cl. 362/485

(57) ABSTRACT

A novelty trailer hitch attachment for vehicle personalization and decorative purposes, comprising an illuminated character attached to a trailer hitch receiver tube and mateably inserted into a trailer hitch socket. The illuminated character may include a human skull likeness, adorned with a sports helmet for a particular sports team or organization. Likewise, the character may include a team or school mascot likeness with similar illumination means. The character receives electrical power via a trailer brake light connector, which provides light via embedded Light Emitting Diodes (LEDs) within the character's structure, projected through the eyes of the character when the vehicle brake pedal is depressed. The present invention provides a novelty trailer hitch item for displaying affiliation or support for a particular sports team or for further accessorizing a vehicle exterior.

### CROSS REFERENCE TO RELATED APPLICATION

This application claims the benefit of U.S. Provisional Application No. 61/379,973 filed on Sep. 3, 2010, entitled “Light Up Your Lights.”

### BACKGROUND OF THE INVENTION

1. Field of the Invention

The present invention relates to novelty trailer hitch articles and vehicle accessories. More specifically, the present invention pertains to an illuminated figure attachable to a trailer hitch receiver tube and adorned in sports equipment for displaying team association and fan loyalty.

2. Description of the Prior Art

Vehicle personalization and aftermarket products are a rapidly growing segment in the motor vehicle market. Today's vehicle consumer has more opportunities than ever to update their standard vehicle to suit particular needs and preferences. These include performance upgrades, audio and electronics upgrades and visual appearance modifications. Exterior personalization and modifications may take several forms, including various lighting schemes, graphics and bodywork to alter the original manufactured styling or properties to fit a user's preferences. The present invention aims to provide a further item for customization and visual appeal. Specifically, the present invention provides an external vehicle accessory that is attachable to a vehicle trailer hitch assembly for novelty and decorative purposes.

Vehicle trailer hitches employ a square receiver socket attached to the hitch assembly, which is secured to the frame of a vehicle. The receiver socket provides an interface for removably attaching various hitch mounts, including as ball mounts, tow hooks and clamp mounts suited for towing wheeled trailers behind a vehicle. The present invention contemplates utilization of an elongated trailer receiver tube for insertion into and attachment to a hitch socket, and to utilize available electrical power designed for use with the tail lights of a towed trailer. The receiver tube slides concentrically into the hitch socket and is pinned into place to prevent movement or dislocation thereof.

Attached to the distal end of the elongated receiver tube is a novelty figure or character for display purposes. The figure resembles a human skull likeness adorned with a helmet, or the head of a popular team mascot, providing passersby with a notice of the owner's sports team affiliation or school association. Illumination means are provided within the interior cavity of the figure and projected outward from the figure's eyes. Utilization of the vehicle brake light connectors provides illumination when the vehicle brake pedal is depressed or when the taillights are otherwise activated.

Several devices and structures have been described in the art for trailer hitch attachments, including novelty arrangements, signs and illuminated placard frames. These devices have familiar design and structural elements for the purposes providing a novelty vehicle accessory, including utilization of a similar attachment point to a vehicle, namely the vehicle trailer hitch assembly; however they fail to fully describe the present invention in structure or intent.

U.S. Pat. No. 6,102,424 to Cole, Jr. describes a removable cover for a tow hitch ball, comprising a decorative cover, locking apparatus and electrically operative connection for accepting a trailer brake light. This device requires a tow hitch ball to be installed onto the trailer hitch in order to provide a cover therefor. It is not a standalone structure that can be concentrically attached to a tow hitch receiver socket, which may be a placeholder for a trailer hitch or take the place of any hitch previously attached therein.

U.S. Pat. No. 6,655,822 to Sylvester describes a decorative trailer hitch cover that protects the hitch receiver from accumulating dirt and debris, and further provides a planar sign or placard for visual purposes. A retaining pin provides securement of the device to the trailer hitch assembly. This device provides for an illuminated sign, as opposed to an ornamental figure or mascot that displays fan affiliation and support for a sports team or school. The sign is a flat, surface member that displays ornamental features thereon, as opposed to the present invention, which is a three dimensional shape with an illuminated ocular region and a human or mascot likeness.

U.S. Pat. No. 6,357,899 to Craven describes a similar device as the Sylvester patent, wherein an illuminated trailer hitch cover is disclosed comprising a decorative designed lens. An automotive light bulb provides illumination through the lens thickness upon depression of the vehicle brake pedal. This device similarly diverges from the present invention by way of its planar lens provides only a two dimensional accessory.

U.S. Pat. No. 6,412,202 to Oswood describes a frame with a placard receiving area, mountable to a trailer hitch receiver socket of a vehicle. Similar to the Craven and Sylvester patents, this patent describes a trailer hitch sign with illumination means. The placard receiving area may be updated with a variety of signage or messages, depending on user preferences. No mention is made of a three dimensional novelty figure disclosed by the present invention.

While these prior art devices fulfill their intended objectives and requirements, they fail to fully describe the present invention in intent or structure. While their means for attachment to a vehicle are similar, the features and ornamental qualities of the present invention substantially diverge in design elements from the prior art. Consequently it is clear that there is a need in the art for an improvement to existing novelty trailer hitch devices. In this regard the instant invention substantially fulfills these needs.

### SUMMARY OF THE INVENTION

In view of the foregoing disadvantages inherent in the known types of novelty vehicle accessories now present in the prior art, the present invention provides a new trailer hitch accessory wherein the same can be utilized for providing convenience for the user when accessorizing a vehicle tailgate and adorning a vehicle with a sports or team affiliation symbol.

It is therefore an object of the present invention to provide an illuminating figure, attachable to a vehicle trailer hitch receiver socket and powered via the trailer brake light electrical connections.

Another object of the present invention is to provide a novelty figure with the likeness of a human skull, adorned in a sports helmet for a particular sports or school team, and for a specific sport.

Yet another object of the present invention is to provide a novelty figure that takes the form of a school mascot.

A final object of the present invention to provide a new and improved novelty trailer hitch accessory device that has all of the advantages of the prior art and none of the disadvantages.

Other objects, features and advantages of the present invention will become apparent from the following detailed description taken in conjunction with the accompanying drawings.

### BRIEF DESCRIPTIONS OF THE DRAWINGS

The above invention will be better understood along with its associated objects, as well as other objects not stated above, will become more apparent after a study of the following detailed description herein. Such description makes use of the annexed drawings wherein:

FIG. 1 shows a perspective view of a first embodiment of the present invention in its working position, attached to a vehicle trailer hitch assembly.

FIG. 2 shows a close-up perspective view of a first embodiment of the present invention, unattached to a vehicle.

FIG. 3 shows a close-up perspective view of an alternate embodiment present invention, unattached to a vehicle.

FIG. 4 shows another close-up perspective view of an alternate embodiment present invention, unattached to a vehicle.

### DETAILED DESCRIPTION OF THE INVENTION

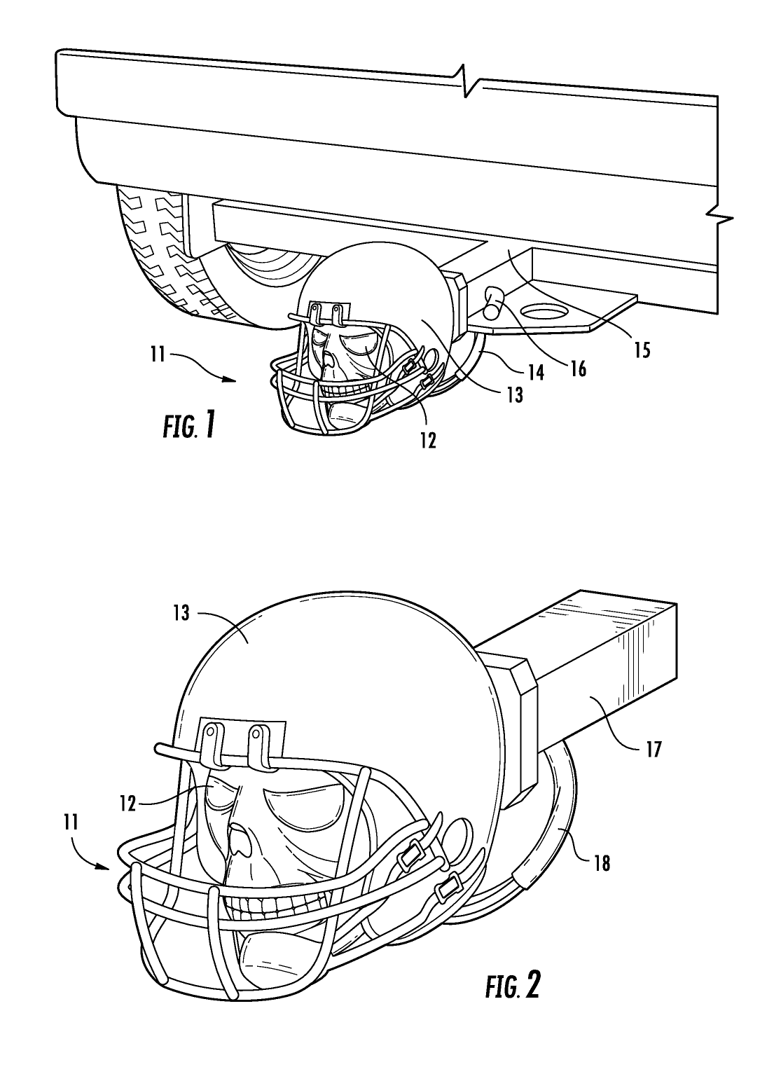

Referring now to FIG. 1, there is shown a perspective view of a first embodiment of the present invention 11, wherein an illuminating figure is attached to a vehicle tail gate assembly, facing rearward from the vehicle. The device comprises a figure with a human skull likeness, illuminating eyes 12 and a sports helmet 13 covering the figure's head. Attached at the back of the sports helmet 13, opposite the facial opening, is a protruding trailer hitch receiver that mateably attaches to a trailer hitch socket 15. The receiver and socket 16 are concentrically mounted and secured using a trailer hitch lock pin 16. The pin 16 secures the two structures together, preventing relative movement of the receiver to the socket. The pin 16 is optionally lockable by the user, provided by a pad lock or similar device. Illumination through the figure's eyes 12 is provided by Light Emitting Diodes (LEDs) embedded within the skull of the figure. Power to the LEDs is fed from the trailer hitch brake light wires, which utilizes a specific connector to send brake light and taillight signals. When the brake lights or taillights are functioning, power is fed through the cable and to the LEDs, illuminating the figure's eyes for passersby and drivers behind the attached vehicle to see.

Referring now to FIG. 2, there is shown a close-up view of a first embodiment of the present invention 11, unattached from a vehicle trailer hitch assembly. In this view, the trailer hitch receiver 17 is shown by itself. The receiver 17 terminates along the backside of the figure sports helmet 13, wherein the helmet 13 is cantilevered from its terminus. The trailer electrical power 18 is utilized to power the imbedded LED lights within the figure's eyes 12. An electrical connector interface is provided for the trailer brake wire 18 along the base of the figure.

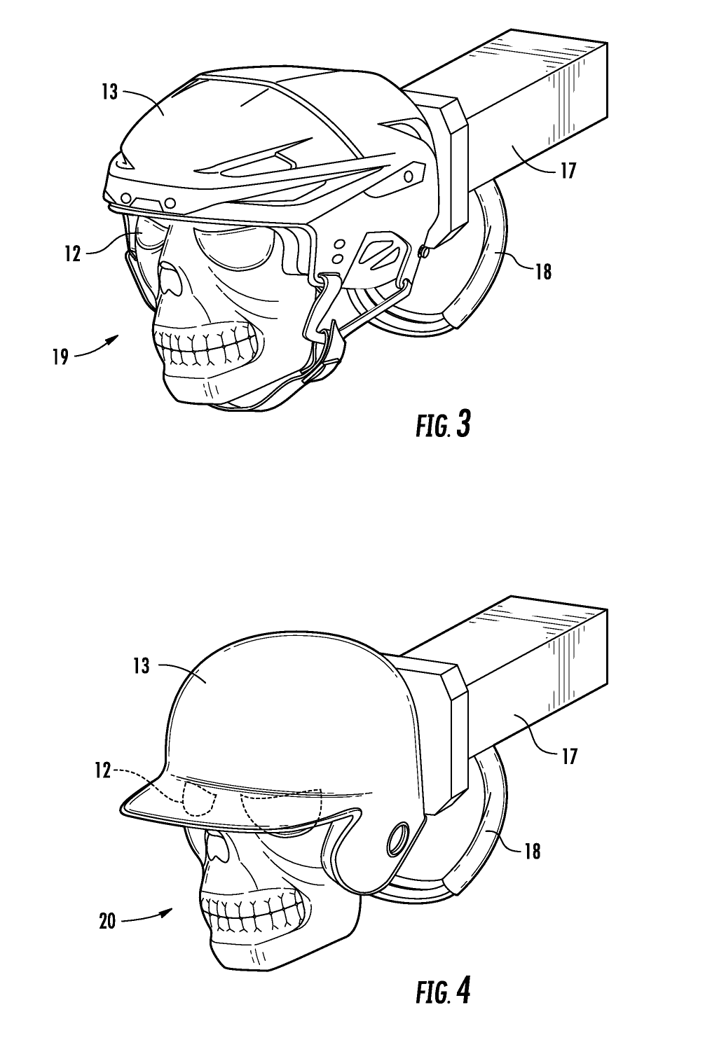

Referring now to FIG. 3 and FIG. 4, there is shown two perspective views of alternate embodiments of the present invention, wherein the same human skull likeness is utilized with a hockey sports helmet 13 and a baseball batter's helmet 20. The same features and properties from the first embodiment remain unchanged, however the sports team and type of sporting gear is updated for user preference. The type of sporting gear may be any facial or head-worn equipment from a sport or position therein, including baseball batting helmets, hockey goalie or player helmets, football helmets, wrestling ear guards or the like. The attachment of the trailer hitch receiver 17 and the electrical connections 18 are identical, along with the illuminating LED eyes. These figures illustrate the versatility of the present invention, wherein any number of sport and school teams and types of sports may be represented and attached to the vehicle trailer hitch, depending on user preferences and affiliations.

In use an individual places the present invention on a trailer hitch assembly by sliding the trailer hitch receiver into the hitch socket and securing the two together with the hitch locking pin. The taillight power connector is connected at the base of the figure, and the brake lights are tested. When the taillights are illuminated or when the brake light is depressed, the figure's eyes vibrantly illuminate for aesthetic and decorative purposes. The human skull likes may further be substituted for a school or sporting team mascot with LED illuminating eyes. This represents the final embodiment of the present invention.

Consumers are always seeking new ways to personalize their vehicles. Many people enjoy displaying loyalty to their favorite sports teams by embellishing their vehicles with bumper stickers, window stick-ons, decorative license plates, and other similar methods. These products can be difficult to see from long distances. Other drivers may not be able to read the words on these products without pulling up close to the user's vehicle, which can be dangerous. A more noticeable, decorative method is desired.

The present invention provides such sports fans and enthusiast with a unique device for dressing and accessorizing their vehicles. The device attaches to the trailer hitch of a vehicle, and comprises a human skull likeness adorned with a sports helmet or team mascot with LED lights for eyes. The helmet and character can be made to resemble the logos and mascots corresponding to specific teams.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A novelty trailer hitch attachment, comprising:
an elongated hitch receiver tube adapted to be attachable to a vehicle trailer hitch socket,
a figure attached to a terminus of said receiver tube, said figure comprising a sports equipment helmet covering and embedded illumination means;
said illumination means project through eyes of said figure;
a trailer tail light connector for receiving brake light and taillight signals from an attached vehicle.

2) A device as in claim 1, wherein said sports equipment helmet includes a particular team logo.

3) A device as in claim 1, wherein said illumination means are light emitting diodes.

4) A novelty trailer hitch attachment, comprising:
an elongated trailer hitch receiver tube, a figure attached to a terminus of said receiver tube, said figure comprising a sports team mascot head with embedded illumination means;
said illumination means project through eyes of said figure;
a trailer tail light connector for receiving brake light and taillight signals from an attached vehicle.

5) A device as in claim 4, wherein said illumination means are light emitting diodes.
